(19) United States
(12) Patent Application Publication
(10) Pub. No.: US 2015/0177973 A1
(43) Pub. Date: Jun. 25, 2015

(54) SELECTION DEVICE

(71) Applicant: Funai Electric Co., Ltd., Osaka (JP)

(72) Inventor: Yoshiharu SHIMIZU, Osaka (JP)

(21) Appl. No.: 14/566,149

(22) Filed: Dec. 10, 2014

(30) Foreign Application Priority Data
Dec. 19, 2013 (JP) 2013-262421

(51) Int. Cl. G06F 3/0484

(52) U.S. Cl. CPC G06F 3/04847; G06F 3/04842

(57) ABSTRACT

A selection device includes a display signal generator, a transition component and a determination component. The display signal generator is configured to generate a display signal for displaying various representative images that represent various selection objects on a display screen of a display device. The transition component is configured to sequentially transition a tentatively selected representative image from among a plurality of representative images representing a plurality of selection objects having the same category based on a first operation signal. The determination component is configured to determine a selection of the tentatively selected representative image based on a second operation signal.

### CROSS-REFERENCE TO RELATED APPLICATIONS

This application claims priority to Japanese Patent Application No. 2013-262421 filed on Dec. 19, 2013. The entire disclosure of Japanese Patent Application No. 2013-262421 is hereby incorporated herein by reference.

### BACKGROUND

1. Field of the Invention

The present invention generally relates to a selection device. More specifically, the present invention relates to a selection device for selecting a representative image that represents a selection object (such as content or a folder).

2. Background Information

The content output device of an optical disk device, an STB (set-top box), television set, or the like displays a representative image, which represents content that can be outputted, on a display device that is built-in, or on an externally connected display device. In the past, representative images that represented content that could be outputted were arranged as tiles and displayed on the display screen of a display device, just as in the display of content information as disclosed in Japanese Laid-Open Patent Application Publication No. 2010-252147 (Patent Literature 1), or program-related information as disclosed in Japanese Laid-Open Patent Application Publication No. 2006-165670 (Patent Literature 2), for example.

With the conventional representative image display, a representative image that represents main content, and representative images that represent first to fifth contents are arranged as tiles, and the representative image is displayed larger than the representative images. Thumbnail images of corresponding content can be used as the representative images.

Also, with the conventional representative image display, a pointer is also displayed in addition to the representative images. The user can change the position of the pointer remotely by using the touch panel of a portable information terminal that functions as a remote control transmitter. An operation to determine selection is performed in a state in which the pointer is superposed over the representative image to be selected, which allows the user to select the desired representative image and, in turn, the content corresponding to the desired representative image.

There are also representative image displays in which the pointer is not displayed, and the tentatively selected representative image is highlighted. In this case, the tentatively selected representative image can be changed remotely by using the key pad of a remote control transmitter. The desired representative image and, in turn, the content corresponding to the desired representative image can be selected by performing an operation to determine the selection of the representative image to be selected in its tentatively selected state.

For example, when one of the representative images, which represents a second sub-content, is selected, this representative image representing the second sub-content is switched with the representative image representing the main content, after which the reproduced image of the second sub-content is displayed in the display region of the representative image. Alternatively, the representative image representing the second sub-content is displayed over the entire screen, after which the reproduced image of the second sub-content is displayed in the display region of the representative image.

### SUMMARY

With the conventional selection method discussed above, the remote operation using a touch panel of a portable information terminal that functions as a remote control transmitter can be difficult for an inexperienced user, and remote operation using the key pad of the remote control transmitter is complicated.

Also, with a display in which the representative image is switched as mentioned above, if there are many representative images, then after the representative image has been switched, the user will have to remember the place where the representative image representing the original content was located when selecting the original content (main content) again, and this made the system inconvenient to use. Also, if selected content is displayed over the entire screen as mentioned above, this results in full-screen display even if content that does not particularly need to be displayed over the entire screen (such as audio content) is selected, and this ends up wasting display space.

One aspect is to provide a selection device with which a selection object (such as content or a folder) can be selected with ease.

In view of the state of the known technology, a selection device includes a display signal generator, a transition component and a determination component. The display signal generator is configured to generate a display signal for displaying various representative images that represent various selection objects on a display screen of a display device. The transition component is configured to sequentially transition a tentatively selected representative image from among a plurality of representative images representing a plurality of selection objects having the same category based on a first operation signal. The determination component is configured to determine a selection of the tentatively selected representative image based on a second operation signal.

Also other objects, features, aspects and advantages of the present disclosure will become apparent to those skilled in the art from the following detailed description, which, taken in conjunction with the annexed drawings, discloses selected embodiments of the selection device.

### BRIEF DESCRIPTION OF THE DRAWINGS

Referring now to the attached drawings which form a part of this original disclosure:

FIG. 1 is a diagram of the simplified configuration of the selection device pertaining to a first embodiment;

FIG. 2 is a diagram of the simplified configuration of a portable information terminal;

FIG. 3 is a flowchart of the operation of the selection device pertaining to the first embodiment;

FIG. 4 is a simplified diagram of the display screen on a display component;

FIG. 5 is a simplified diagram of the display screen on a display component;

FIG. 6 is a simplified diagram of the display screen on a display component;

FIG. 7 is a front view of a portable information terminal;

FIG. 8 is a simplified diagram of the display screen on a display component;

FIG. 9 is a simplified diagram of the display screen on a display component;

FIG. 10 is a simplified diagram of the display screen on a display component;

FIG. 11 is a simplified diagram of the display screen on a display component;

FIG. 12 is a simplified diagram of the display screen on a display component;

FIG. 13 is a flowchart of the operation of the selection device pertaining to a second embodiment; and

FIG. 14 is a front view of a portable information terminal.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

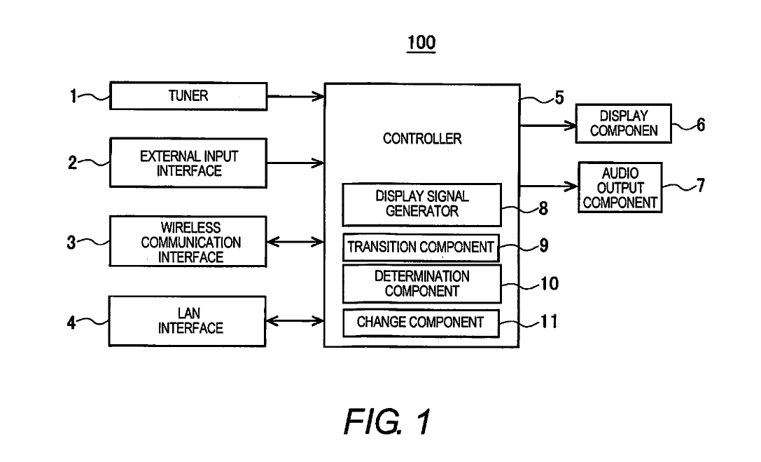

FIG. 1 is a diagram of the simplified configuration of the selection device pertaining to a first embodiment. The simplified configuration of a television set 100, which is a selection device pertaining to the first embodiment, will be described. The television set 100 is a selection device with a built-in display device, and comprises a tuner 1, an external input interface 2, a wireless communication interface 3, a LAN interface 4, a controller 5, a display component 6 corresponding to the display device, and an audio output component 7.

The tuner 1 performs tuning, demodulation, and other such processing on broadcast signals supplied from an antenna, etc., and outputs program data (content data) for the tuned-in broadcast channel to the controller 5.

The external input interface 2 can be connected to an external content output device via an HDMI™ cable, for example, and outputs the content data supplied from the external content output device to the controller 5. Examples of external content output devices include optical disk devices, hard disk devices, and combinations of these.

The wireless communication interface 3 can communicate wirelessly with an external wireless communications device, and outputs remote control signals or the content data supplied from the external wireless communications device to the controller 5. There are no particular restrictions on the wireless communications method, but examples include Bluetooth™ communication and Wi-Fi™ communication. The wireless communication interface 3 can be configured to be compatible with only a single wireless communication method, or configured to be compatible with two or more wireless communication methods.

The LAN interface 4 can be connected to an external LAN router or the like via a LAN cable. Even if the wireless communication interface 3 is not compatible with Wi-Fi™ communication, Wi-Fi™ communication between the television set 100 and a wireless communication device can be achieved by connecting an external wireless LAN router to the LAN interface 4.

The controller 5 is constituted as a system-on-chip (SoC), and controls the entire television set 100. The controller 5 executes specific programs stored non-volatilely, and operates as a controller having a display signal generator 8, a transition component 9, a determination component 10, and a change component 11. The display signal generator 8, the transition component 9, the determination component 10, and the change component 11 will be discussed in detail below.

In the illustrated embodiment, the controller 5 preferably includes a microcomputer with programs that control the entire television set 100. The controller 5 can also include other conventional components such as an input interface circuit, an output interface circuit, and storage devices such as a ROM (Read Only Memory) device and a RAM (Random Access Memory) device. The microcomputer of the controller 5 is programmed to control the television set 100. The memory circuit stores processing results and control programs that are run by the processor circuit. The controller 5 is operatively coupled to other components of the television set 100 in a conventional manner. The internal RAM of the controller 5 stores statuses of operational flags and various control data. The internal ROM of the controller 5 stores the programs and parameters for various operations. The controller 5 is capable of selectively controlling any of the components of the television set 100 in accordance with the control program. It will be apparent to those skilled in the art from this disclosure that the precise structure and algorithms can be any combination of hardware and software that will carry out the functions of the present invention.

The display component 6 performs display based on the display signals outputted from the controller 5. There are no particular restrictions on the type of the display component 6, but it is preferably a flat-screen display component such as a liquid crystal display, and is preferably a large-screen display component with high resolution that allows numerous representative images to be displayed properly (such as a resolution of 3840×2160 pixels, or a resolution of 4096×2160 pixels).

The audio output component 7 is constituted by a speaker, and performs audio output based on the audio signals outputted from the controller 5.

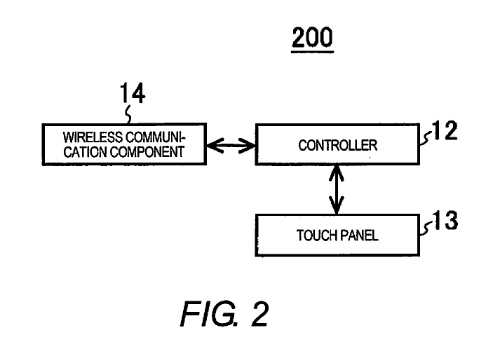

FIG. 2 is a diagram of the simplified configuration of a portable information terminal 200 (an example of a wireless communication device). The portable information terminal 200 (such as a smart phone or a tablet terminal) comprises a controller 12, a touch panel 13, and a wireless communication component 14.

The controller 12 controls the entire portable information terminal 200, and stores an operating system called Android™ in an internal memory, for example, to perform control operations according to this operating system. The controller 12 also stores in its internal memory dedicated application software (hereinafter referred to as “apps”) for carrying out the remote operation of the television set 100. The controller 12 also stores content in its internal memory.

In the illustrated embodiment, the controller 12 preferably includes a microcomputer with programs that control the portable information terminal 200. The controller 12 can also include other conventional components such as an input interface circuit, an output interface circuit, and storage devices such as a ROM (Read Only Memory) device and a RAM (Random Access Memory) device. The microcomputer of the controller 12 is programmed to control the portable information terminal 200. The memory circuit stores processing results and control programs that are run by the processor circuit. The controller 12 is operatively coupled to other components of the portable information terminal 200 in a conventional manner. The internal RAM of the controller 12 stores statuses of operational flags and various control data. The internal ROM of the controller 12 stores the programs and parameters for various operations. The controller 12 is capable of selectively controlling any of the components of the portable information terminal 200 in accordance with the control program. It will be apparent to those skilled in the art from this disclosure that the precise structure and algorithms can be any combination of hardware and software that will carry out the functions of the present invention.

The touch panel 13 is an input component that receives user commands, and is also a display component that displays content images and so forth. The wireless communication component 14 performs wireless communication with the wireless communication interface 3 of the television set 100, or with a wireless LAN router connected to the LAN interface 4 of the television set 100.

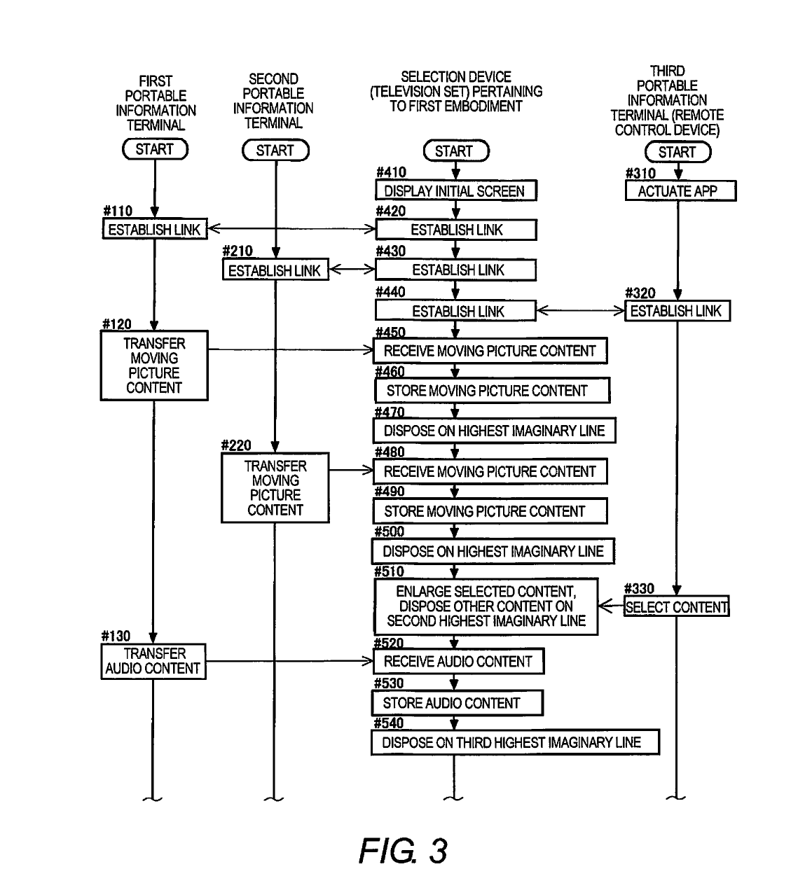

The operation of the selection device (television set 100) pertaining to the first embodiment will now be described through reference to the flowchart in FIG. 3. The configuration of the first to third portable information terminals shown in FIG. 3 is the same as the configuration of the portable information terminal 200 shown in FIG. 2.

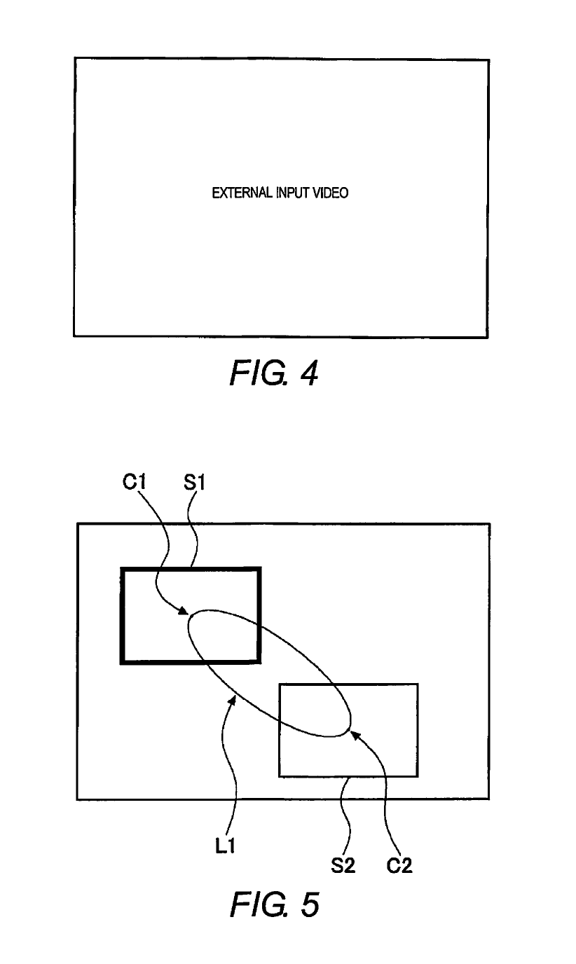

Here, we will describe a situation in which flow operation is commenced in a state in which the television set 100 is not in external input mode. First, the television set 100 displays an external input image (video based on the content data supplied from an external content output device to the external input interface 2) over the entire display screen of the display component 6 as shown in FIG. 4, which is the initial screen on the display component 6 (step #410).

When the user uses the touch panel 13 of the third portable information terminal to actuate an app, that app is actuated on the third portable information terminal, and the third portable information terminal operates as a remote control device (step #310).

Next, a wireless communication link is established between the television set 100 and the first portable information terminal (steps #110 and #420). This link can be established by any method. For example, it can be established in response to a specific user input to the first portable information terminal, or it can be established automatically when the first portable information terminal is located within the wireless communication range of the television set 100. As mentioned above, this link between the television set 100 and first portable communication link can be established by any method conventionally well-known in the art, such as Bluetooth™, Wi-Fi™ and the like. Also, as described below, links between the television set 100 and other portable information terminals can be established in a manner similar to this link.

Next, a wireless communication link is established between the television set 100 and the second portable information terminal (steps #210 and #430). This link can be established by any method. For example, it can be established in response to a specific user input to the second portable information terminal, or it can be established automatically when the second portable information terminal is located within the wireless communication range of the television set 100.

Next, a wireless communication link is established between the television set 100 and the third portable information terminal (steps #320 and #440). This link can be established by any method. For example, it can be established in response to a specific user input to the third portable information terminal, or it can be established automatically when the third portable information terminal is located within the wireless communication range of the television set 100.

The sequence of link establishment can be different from that given above. Also, the sequence of steps #310 and #320 can be different.

When data for moving picture data is transferred from the first portable information terminal to the television set 100 (step #120), the television set 100 receives the transferred moving picture data (step #450) and stores the received data in a built-in memory of the controller 5 (step #460). The transferred moving picture content is content of the same category as external input video (video content). Therefore, the display signal generator 8 of the television set 100 generates display signals for making the display component 6 give a display in which a thumbnail image S1 representing external input video, and a thumbnail image S2 representing video content transferred from the first portable information terminal are disposed on a highest imaginary line L1 (step #470).

When the processing of step #470 is finished, there are only two sets of content to be selected: external input video and moving picture content transferred from the first portable information terminal. When the processing of step #470 is finished, the display component 6 performs the display shown in FIG. 5. The thumbnail image S1 is highlighted since it is in a tentatively selected state. In the display in FIG. 5, the thumbnail images S1 and S2 are disposed so that the center C1 of the thumbnail image S1 and the center C2 of the thumbnail image S2 each overlap with the highest imaginary line L1. The highest imaginary line L1 is in the form of a loop, so that its starting point and end point match up. Also, since the highest imaginary line L1 is nothing but an imaginary line, it is not actually displayed. The other imaginary lines discussed below (the second highest imaginary line L2 and the third highest imaginary line L3) are similar to the highest imaginary line L1 in that they are in the form of a loop, so that their starting points and end points match up, but are not actually displayed. However, alternatively, the imaginary lines can be displayed.

In this embodiment, it is assumed that just one set of moving picture content has been transferred from the first portable information terminal in order to simplify the description, but there can be two or more sets of moving picture content transferred from the first portable information terminal. If there are two or more sets of moving picture content transferred from the first portable information terminal, a thumbnail image corresponding to each set should be displayed.

Next, when data for the moving picture content is transferred from the second portable information terminal to the television set 100 (step #220), the television set 100 receives the transferred data for moving picture data (step #480) and stores the received data in the built-in memory of the controller 5 (step #490). The moving picture content transferred from the second portable information terminal is content of the same category (video content) as the external input video and the moving picture content transferred from the first portable information terminal. Therefore, the display signal generator 8 of the television set 100 generates display signals for making the display component 6 give a display in which the thumbnail image Si representing external input video, the thumbnail image S2 representing video content transferred from the first portable information terminal, and a thumbnail image S3 representing moving picture content transferred from the second portable information terminal are disposed on a highest imaginary line L1 (step #500).

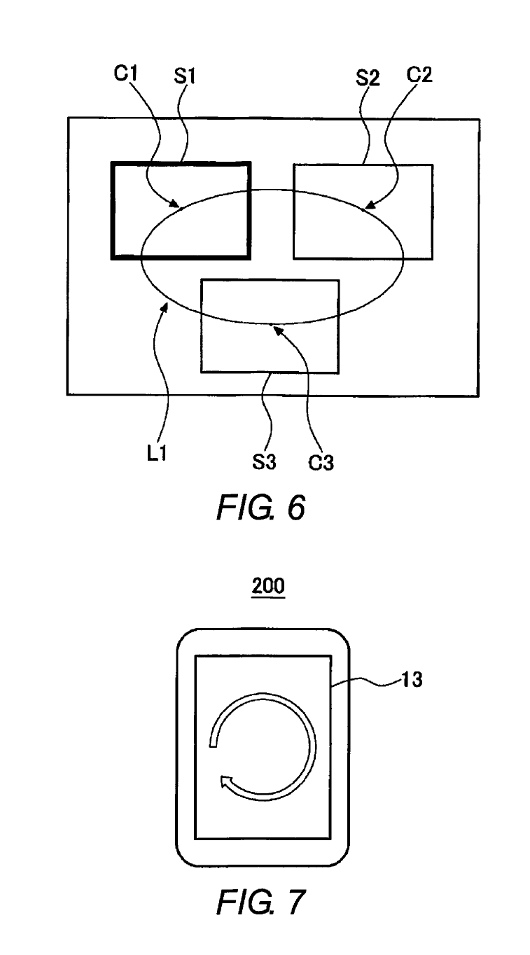

When the processing of step #500 is finished, there are three sets of selected content: external input video, the moving picture content transferred from the first portable information terminal, and the moving picture content transferred from the second portable information terminal. When the processing of step #500 is finished, the display component 6 performs the display shown in FIG. 6. The thumbnail image S1 is highlighted since it is in a tentatively selected state. In the display in FIG. 6, the thumbnail images S1 to S3 are disposed so that the center C1 of the thumbnail image S1, the center C2 of the thumbnail image S2, and the center C3 of the thumbnail image S3 each overlap with the highest imaginary line L1. In the illustrated embodiment, the highest imaginary line L1 used before step #330 can be predetermined according to the number of thumbnail images arranged on the highest imaginary line L1. Specifically, in the memory of the controller 5, the size and the orientation of the elliptic highest imaginary line L1 are pre-stored according to the number of thumbnail images arranged on the highest imaginary line L1, as shown in FIGS. 5 and 6. However, alternatively, the size and the orientation of the elliptic highest imaginary line L1 can be calculated based on the number of thumbnail images arranged on the highest imaginary line L1. In FIGS. 5 and 6, the cases in which the numbers of the thumbnail images are two and three are shown. However, of course, the numbers of the thumbnail images can be different from two or three.

In this embodiment, it is assumed that just one set of moving picture content has been transferred from the second portable information terminal in order to simplify the description, but there can be two or more sets of moving picture content transferred from the second portable information terminal. If there are two or more sets of moving picture content transferred from the second portable information terminal, a thumbnail image corresponding to each set should be displayed.

Next, a first operation signal and a second operation signal for selecting content according to user input on the touch panel are sent by the third portable information terminal to the television set 100 (step #330).

When the user puts a finger on the touch panel 13 and rotates it clockwise as shown in FIG. 7, the third portable information terminal sends a first operation signal every time the finger rotates by a specific angle. The transition component 9 of the television set 100 sequentially transitions the tentatively selected representative image based on the first operation signal. When the television set 100 receives the first operation signal in a state in which the display component 6 is giving the display shown in FIG. 6, the thumbnail image S2 is highlighted instead of the thumbnail image S1. When the television set 100 receives the first operation signal while the thumbnail image S2 is highlighted, the thumbnail image S3 is highlighted instead of the thumbnail image S2. When the television set 100 receives the first operation signal while the thumbnail image S3 is highlighted, the thumbnail image S1 is highlighted instead of the thumbnail image S3, and the display returns to what is shown in FIG. 6.

After this, when the user taps on the center of the touch panel 13, the third portable information terminal sends a second operation signal. The determination component 10 of the television set 100 determines the selection of the tentatively selected representative image based on the second operation signal. When the television set 100 receives the second operation signal while the display shown in FIG. 6 is being given on the display component 6, the selection of the thumbnail image S1 is determined.

The display signal generator 8 of the television set 100 enlarges the selected content (here, content corresponding to the thumbnail image S1) to a specific display size, and generates a display signal for making the display component 6 give a display in which the thumbnail images S2 and S3 are disposed so that the center C2 of the thumbnail image S2 and the center C3 of the thumbnail image S3 each overlap with the second highest imaginary line L2 (step #510).

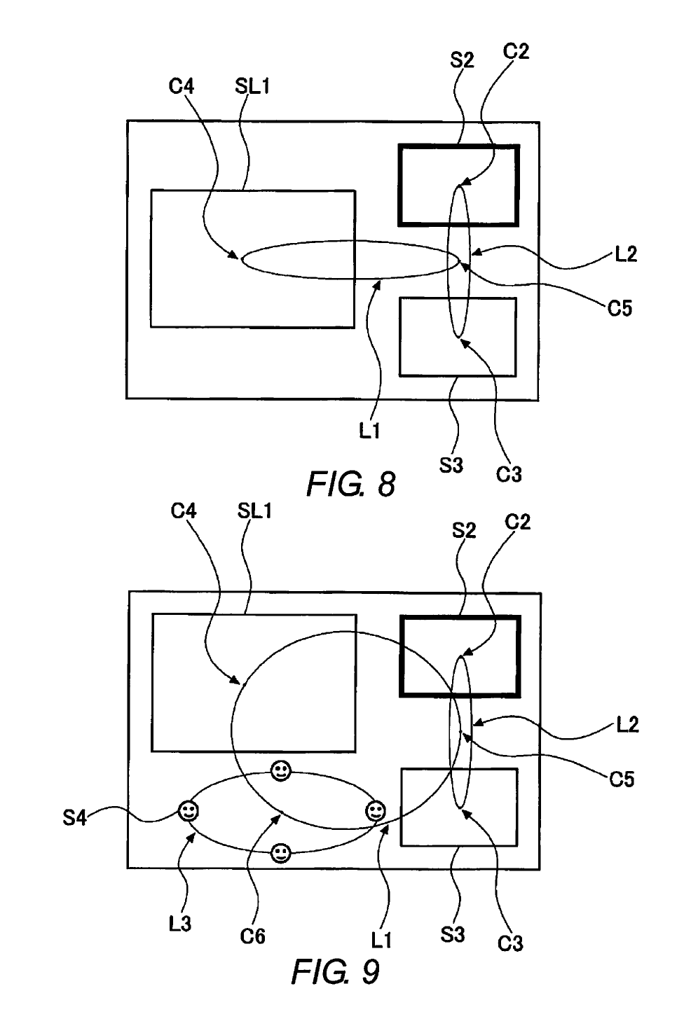

When the processing of step #510 is finished, the display component 6 gives the display shown in FIG. 8. The thumbnail image S2 is highlighted since it is in a tentatively selected state. In the display shown in FIG. 8, the thumbnail images S2 and S3 are disposed so that the center C2 of the thumbnail image S2 and the center C3 of the thumbnail image S3 each overlap with the second highest imaginary line L2. In the display shown in FIG. 8, a display region SL1 and the second highest imaginary line L2 are disposed so that the center C4 of the display region SL1 of the selected content and the center C5 of a region bounded by the second highest imaginary line L2 each overlap with the highest imaginary line L1. In the illustrated embodiment, the second highest imaginary line L2 can be predetermined according to the number of thumbnail images arranged relative to the second highest imaginary line L2. Specifically, in the memory of the controller 5, the size and the orientation of the elliptic second highest imaginary line L2 are pre-stored according to the number of thumbnail images arranged relative to the highest imaginary line L2, as shown in FIGS. 8 to 12. However, alternatively, the size and the orientation of the elliptic second highest imaginary line L2 can be calculated based on the number of thumbnail images arranged relative to the second highest imaginary line L2. In FIGS. 8 to 12, the cases in which the numbers of the thumbnail images arranged relative to the second highest imaginary line L2 are two and three are shown. However, of course, the numbers of the thumbnail images can be different from two or three. Also, in the illustrated embodiment, the thumbnail images arranged relative to the second highest imaginary line L2 are equidistantly arranged along the major axis of the elliptic second highest imaginary line L2. In particular, the centers of the thumbnails displayed top and bottom are disposed on the ends of the major axis of the elliptic second highest imaginary line L2, while the center of the rest of the thumbnails is arranged along the major axis of the elliptic second highest imaginary line L2 such that the centers of the thumbnails are equidistantly arranged along the major axis of the elliptic second highest imaginary line L2, for example.

Furthermore, the size and the orientation of the highest imaginary line L1 displayed in response to the processing of step #510 can be predetermined. Specifically, in the memory of the controller 5, the size and the orientation of the elliptic highest imaginary line L1 displayed in response to the processing of step #510 are pre-stored as shown in FIG. 8 such that the center C4 of the display region SL1 of the selected content and the center C5 of a region bounded by the second highest imaginary line L2 are disposed on the ends of the major axis of the elliptic highest imaginary line L1.

When data for audio content is transferred from the first portable information terminal to the television set 100 (step #130), the television set 100 receives the transmitted audio content data (step #520), and stores the received data in the built-in memory of the controller 5 (step #530). The transferred audio content is of a different category from that of the video content. Accordingly, the display signal generator 8 of the television set 100 generates a display signal for making the display component 6 give a display in which an icon image S4 representing audio content is disposed on the third highest imaginary line L3 (step #540).

When the processing of step #540 is finished, the display component 6 gives the display shown in FIG. 9. The display shown in FIG. 9 is an example of the display when four sets of content have been transferred from the first portable information terminal. With the display shown in FIG. 9, the third highest imaginary line L3 is disposed so that the center C6 of the region bounded by the third highest imaginary line L3 overlaps the highest imaginary line L1. In the illustrated embodiment, the third highest imaginary line L3 can be predetermined. Specifically, in the memory of the controller 5, the size and the orientation of the elliptic third highest imaginary line L3 can be pre-stored as shown in FIG. 9. However, alternatively, the size and the orientation of the elliptic third highest imaginary line L3 can be calculated.

Furthermore, the size and the orientation of the highest imaginary line L1 displayed in response to the processing of step #540 can be predetermined. Specifically, in the memory of the controller 5, the size and the orientation of the elliptic highest imaginary line L1 displayed in response to the processing of step #540 are pre-stored as shown in FIG. 9 such that the center C4 of the display region SL1 of the selected content, the center C5 of the region bounded by the second highest imaginary line L2, and the center C6 of the region bounded by the third highest imaginary line L3 are disposed on the elliptic highest imaginary line L1.

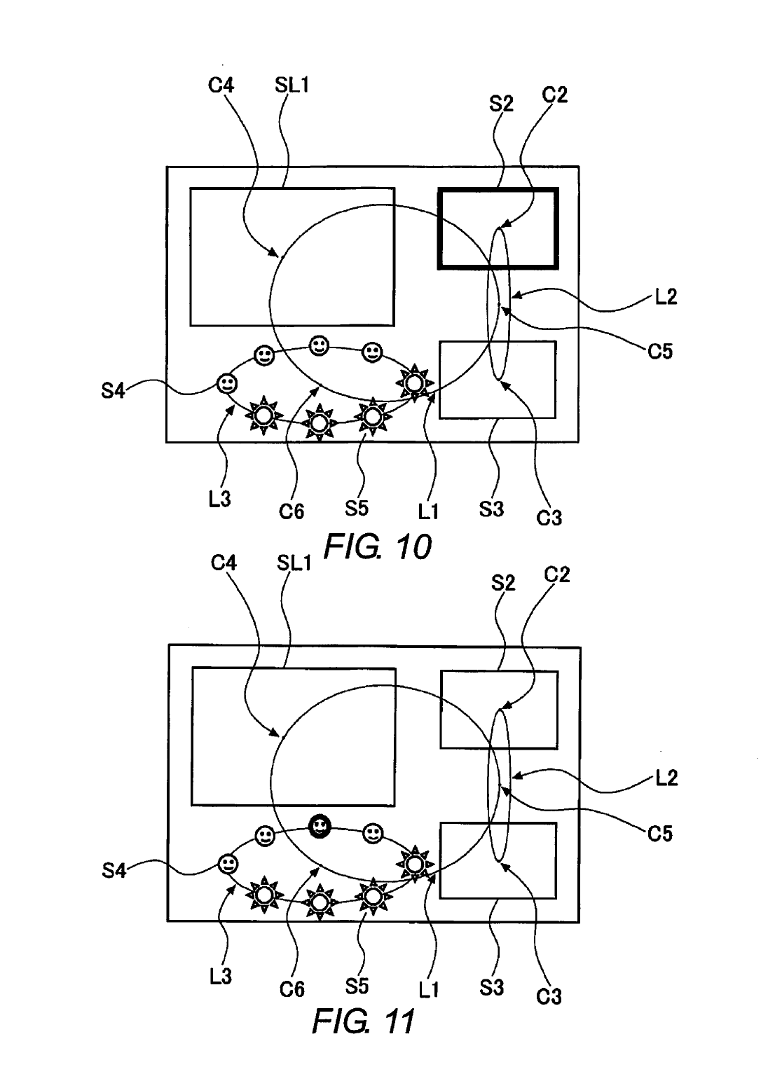

Although not depicted in FIG. 3, when audio content data is transferred from the second portable information terminal to the television set 100, the television set 100 receives the transferred audio content data, and stores the received data in the built-in memory of the controller 5. The audio content transferred from the second portable information terminal is content of the same category as the audio content transferred from the first portable information terminal. Accordingly, the display signal generator 8 of the television set 100 generates a display signal for making the display component 6 give a display in which the icon images S4 and S5 representing the audio content transferred from the first and second portable information terminals are disposed on the third highest imaginary line L3. When this processing is finished, the display component 6 gives the display shown in FIG. 10. The display shown in FIG. 10 is an example of the display when four sets of content have been transferred from the second portable information terminal.

Then, the third portable information terminal sends a third operation signal for changing the category to the television set 100 according to user input on the touch panel.

When the user puts a finger on the touch panel 13 and flicks in a specific direction (such as upward), the third portable information terminal sends a third operation signal. When the user flicks the touch panel 13 in another specific direction (such as downward), the third portable information terminal sends a fourth operation signal. The change component 11 of the television set 100 changes the content category corresponding to the representative image that will be tentatively selected by the transition component 9, based on the third operation signal or the fourth operation signal. When the television set 100 receives the third operation signal while the display component 6 is giving the display shown in FIG. 10, the change component 11 changes the content category corresponding to the representative image that will be tentatively selected by the transition component 9 to the category corresponding to the next lower imaginary line, resulting in the display shown in FIG. 11. Conversely, if the television set 100 receives the fourth operation signal while the display component 6 is giving the display shown in FIG. 11, the change component 11 changes the content category corresponding to the representative image that will be tentatively selected by the transition component 9 to the category corresponding to the next higher imaginary line, resulting in the display shown in FIG. 10. In this embodiment, two types of operation signal were provided for changing the content category corresponding to the representative image that will be tentatively selected by the transition component 9, but there can be just one type of operation signal, and the change in category can be looped around based on that one type of operation signal.

When the television set 100 receives the second operation signal while the display component 6 is giving the display shown in FIG. 11, the selection of the tentatively selected icon image S4 (the highlighted icon image S4) is determined, and reproduction of the audio content corresponding to the selected icon image S4 is begun.

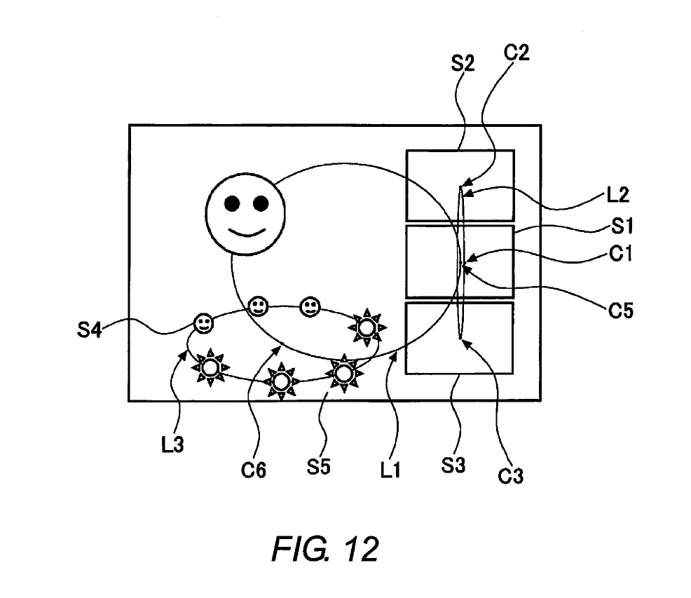

When the audio content corresponding to the selected icon image S4 is being reproduced, the icon image S4 representing the reproduced audio content is enlarged and disposed on the highest imaginary line L1 as shown in FIG. 12. This allows the user to easily ascertain which audio content is being reproduced. Also, in FIG. 12, the region bounded by the second highest imaginary line L2 has a slender shape, so the thumbnail images S1 to S3 disposed on the second highest imaginary line L2 appear to be disposed on the same straight line.

The audio content corresponding to the selected icon image S4 can be reproduced while the display shown in FIG. 11 is still there, without switching from the display shown in FIG. 11 to the display shown in FIG. 12.

The television set 100 pertaining to the embodiment described above has a configuration comprising the display signal generator 8, which generates a display signal for displaying a single screen various representative images that represent various selection objects out of all selection objects (contents), on the display screen of the display device 6; the transition component 9 that sequentially transitions a representative image tentatively selected from among the plurality of representative images representing a plurality of selection objects of the same category included in all of the selection objects, based on a first operation signal; and the determination component 10 that determines the selection of the tentatively selected representative image based on a second operation signal.

Because of this configuration, all of the selection objects can be checked on the display screen of the display component 6 at the same time, and the operation for tentative selection and the operation for main selection can be simplified, so selection objects can be easily selected.

Also, the television set 100 in this embodiment is configured so that the transition component 9 can loop the tentatively selected representative images around based on the first operation signal.

With this configuration, there is no need for the operation to transition the tentatively selected representative image in the opposite direction, so the operation for performing tentative selection can be simplified even more.

Also, with the television set 100 in this embodiment, a plurality of representative images representing a plurality of selection objects of the same category included in all of the selection object are disposed on the same imaginary line, so the display signal generator 8 sets the region on the display screen where the plurality of representative images representing a plurality of selection objects of the same category included in all of the selection objects are disposed, by category.

It is easy to arrange displays compiled by category. The regions on the display screen that are set by category can be portions that overlap between a plurality of regions.

Also, with the television set 100 in this embodiment, when the selection object corresponding to the representative image whose selection was determined by the determination component 10 is video content, the display signal generator 8 sets the display size of the selection object corresponding to the representative image whose selection was determined by the determination component 10 to a specific size.

With this configuration, even if the number of representative images increases, the display size of the selected video content can be kept constant, allowing the user to enjoy the selected video content as desired.

Also, the television set 100 in this embodiment has a configuration comprising the change component 11 that changes the category of the selection object corresponding to the representative image that will be tentatively selected by the transition component 9. With this configuration, the selection objects of each category can be tentatively selected objects.

In the illustrated embodiment, as shown in FIGS. 5 and 6, the display signal generator 8 arranges the thumbnail images S1, S2, S3 (e.g., the representative images) representing the selection objects having the same category (e.g., the moving picture content) along the highest imaginary line L1 (e.g., the imaginary loop or the imaginary ellipse) on the display component 6. The display signal generator 8 further arranges the centers C1, C2, C3 of the thumbnail images S1, S2, S3 (e.g., the representative images) representing the selection objects having the same category (e.g., the moving picture content) on the highest imaginary line L1 (e.g., the imaginary loop or the imaginary ellipse) on the display component 6. Also, the display signal generator 8 further displays the thumbnail image S1 (e.g., the tentatively selected representative image) in a distinguishing manner (e.g., in a highlighted manner) from the remainder of the thumbnail image S2, S3 (e.g., the representative images).

Also, in the illustrated embodiment, as shown in FIGS. 9 to 12, the display signal generator 8 arranges the icon images S4, S5 (e.g., the representative images) representing the selection objects having the same category (e.g., the audio content) along the third highest imaginary line L3 (e.g., the imaginary loop or the imaginary ellipse) on the display component 6. The display signal generator 8 further arranges the centers of the icon images S4, S5 (e.g., the representative images) representing the selection objects having the same category (e.g., the audio content) on the third highest imaginary line L3 (e.g., the imaginary loop or the imaginary ellipse) on the display component 6. Also, the display signal generator 8 further displays the icon image (e.g., the tentatively selected representative image) in a distinguishing manner (e.g., in a highlighted manner) from the remainder of the icon image (e.g., the representative images).

Also, in the illustrated embodiment, as shown in FIGS. 8 to 12, the display signal generator 8 displays the tentatively selected representative image (SL1 or icon image in FIG. 12) larger than the remainder of the thumbnail images or the icon images (e.g., the representative images) in response to the determination component 10 determining the selection of the tentatively selected representative image. Also, the display signal generator 8 further arranges the remainder of the thumbnail images S2, S3 or the icon images S4, S5 (e.g., representative images) along the second highest imaginary line L2 or the third highest imaginary line L3 (e.g., the imaginary loops) on the display component 6. Furthermore, as shown in FIGS. 8 to 12, the display signal generator 8 arranges the centers C2, C3 of the thumbnail images S2, S3 (e.g., the remainder of the representative images) on the major axis of the second highest imaginary line L2 (e.g., the axis of the imaginary loop) on the display component 6. Also, as shown in FIGS. 8 to 12, the display signal generator 8 arranges the tentatively selected representative image (SL1) relative to the thumbnail images S2, S3 (e.g., the remainder of the representative images) such that the center C4 of the tentatively selected representative image (SL1) and the center C5 of the second highest imaginary line L2 (e.g., the imaginary loop) are arranged on the first highest imaginary line 11 (e.g., the imaginary loop) in response to the determination component 10 determining the selection of the tentatively selected representative image.

Furthermore, in the illustrated embodiment, as shown in FIGS. 8 to 12, the display signal generator 8 arrange, for each category, the thumbnail images S1, S2, S3 or the icon images S4, S5 (e.g., the representative images representing the selection objects having the same category) along the second highest imaginary line L2 or the third highest imaginary line L3 (e.g., the imaginary loop).

### Second Embodiment

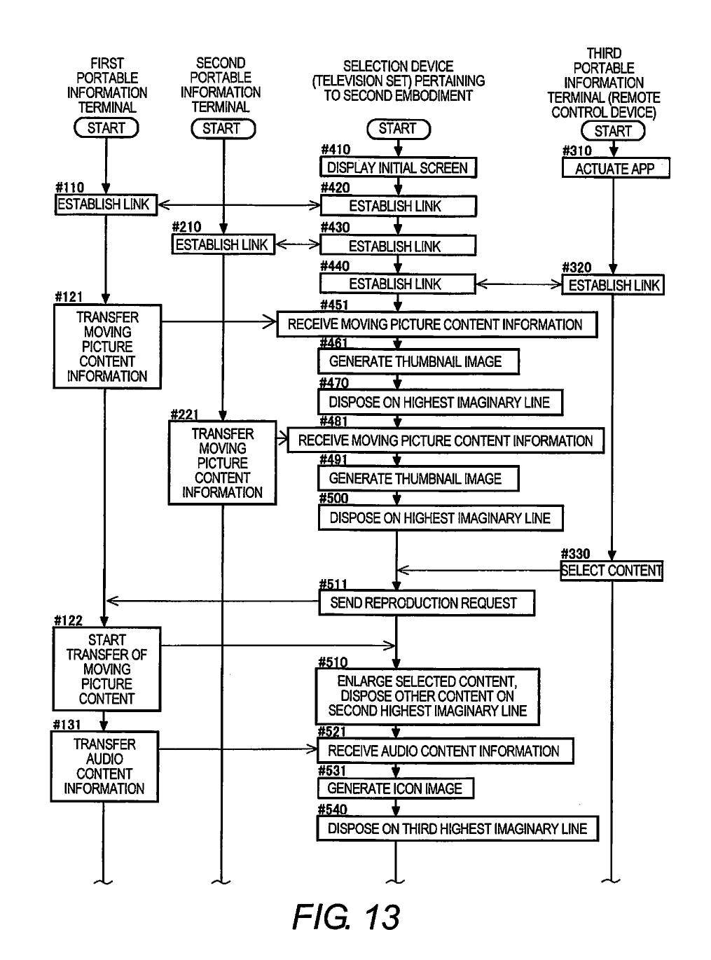

Referring now to FIG. 13, a selection device in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The basic configuration of the selection device pertaining to a second embodiment is the same as the basic configuration of the selection device pertaining to the first embodiment.

Also, the basic operation of the selection device in this embodiment, and the various displays of the display component 6 are the same as those in the first embodiment.

In the operation of the selection device in this embodiment, those portions that are different from the first embodiment will be described through reference to the flowchart in FIG. 13.

In this embodiment, after a wireless communication link has been established, moving picture content data is transferred from the first portable information terminal to the television set 100.

When moving picture content data is transferred from the first portable information terminal to the television set 100 (step #121), the television set 100 receives the transferred moving picture data (step #451) and uses the received data to generate a thumbnail image S2 that represents moving picture content (step #461).

In this embodiment, when the processing in step #470 is finished, moving picture content data is transferred from the second portable information terminal to the television set 100.

When moving picture content data is transferred from the second portable information terminal to the television set 100 (step #221), the television set 100 receives the transferred moving picture content data (step #481), and uses the received data to generate a thumbnail image S3 that represents moving picture content (step #491).

In this embodiment, the television set 100 sends a reproduction request signal to the first portable information terminal that is storing the selected content (here, content corresponding to the thumbnail image S2) (step #511). The first portable information terminal responds to this reproduction request signal by transferring content data corresponding to the thumbnail image S2 to the television set 100 (step #122).

In this embodiment, after the processing in step #510 is finished, audio content data is transferred from the first portable information terminal to the television set 100.

When audio content data is transferred from the first portable information terminal to the television set 100 (step #131), the television set 100 receives the transferred audio content data (step #521), and uses the received data to generate an icon image S4 that represents the audio content (step #531).

Although not depicted in FIG. 13, when audio content data is transferred from the second portable information terminal to the television set 100, the television set 100 receives the transferred audio content data, and uses the received data to generate an icon image S5 that represents the audio content.

The selection device in this embodiment has the same effect as the selection device in the first embodiment. Also, with the selection device in this embodiment, since not all of the selection objects (contents) need to be stored, the memory capacity of the controller 5 can be reduced.

### Third Embodiment

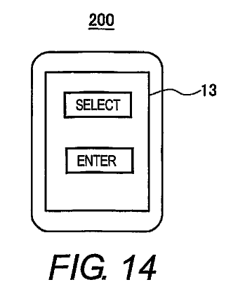

Referring now to FIG. 14, a selection device in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

The basic configuration of the selection device pertaining to a third embodiment is the same as the basic configuration of the selection device pertaining to the first embodiment.

Also, the basic operation of the selection device in this embodiment, and the various displays of the display component 6 are the same as those in the first embodiment.

In this embodiment, the touch panel operation performed by the user in order to send the first operation signal and the second operation signal to the third portable information terminal differs from that in the first embodiment.

When the actuation of an app is finished at the third portable information terminal, the two software keys shown in FIG. 14 (a “select” key and an “enter” key) are displayed on the touch panel 13 of the third portable information terminal.

When the user puts a finger on the “select” key of the touch panel 13 and holds it there, the third portable information terminal sends a first operation signal at specific time intervals. After this, when the user removes his finger from the “select” key and taps the “enter” key of the touch panel 13, the third portable information terminal sends a second operation signal.

The selection device in this embodiment has the same effect as the selection device in the first embodiment.

### Other Embodiments

With the embodiments given above, thumbnail images were used as the representative images that represented moving picture content, and icon images were used as the representative images that represented audio content, but the representative images are not limited to being thumbnail images or icon images. For example, they can be text string images that can be produced from text data.

Also, in the above embodiments, the category was classified by a distinction between video content and audio content, but the category can instead be classified based on the device that stores the content, on the person who produced the content, on the date and time when the content was produced, and so forth.

Also, in the above embodiments, every time the tentatively selected representative image changed, the position of the highlighted representative image changed, but the position of the highlighted representative image can be fixed as long as there is no change in the category, and the display position can be switched among the various representative images that will be tentatively selected whenever the tentatively selected representative image changes.

Also, in the above embodiments, the tentatively selected representative image can be looped around based on the first operation signal, but the configuration can instead be such that this looping cannot be done. If looping cannot be done, then preferably when the user's finger touches the touch panel 13 and is rotated clockwise as shown in FIG. 7, for example, the third portable information terminal sends a first operation signal every time the finger rotates by a specific angle, and when the user's finger touches the touch panel 13 and is rotated counter-clockwise, the third portable information terminal sends a first opposite-operation signal every time the finger rotates by a specific angle. The configuration can be such that the transition component 9 of the television set 100 sequentially transitions the tentatively selected representative image based on the first operation signal, and sequentially transitions in the opposite direction from that in transition based on the first operation signal, based on the first opposite-operation signal.

Also, in the above embodiments, the selection object was only content, but the selection object is not limited to being content. For instance, a folder containing one or more sets of content can be included in the selection object. If a folder is selected, for example, all of the contents in the selected folder can be sequentially reproduced, or representative images representing all of the contents in the selected folder can be disposed on the highest imaginary line. The category of the folder can be decided based on the category of the content in the folder, for example.

In the illustrated embodiment, the selection device has a configuration (first configuration) including a display signal generator configured to generate a display signal for displaying various representative images that represent various selection objects on a display screen of a display device, a transition component configured to sequentially transition a tentatively selected representative image from among a plurality of representative images representing a plurality of selection objects having the same category based on a first operation signal, and a determination component configured to determine a selection of the tentatively selected representative image based on a second operation signal.

With this configuration, all of the selection objects can be checked at the same time, and since the operation for performing tentative selection and the operation for performing main selection are simple, a selection object can be selected with ease.

With the selection device in the above first configuration, the transition component can be further configured to sequentially transition the tentatively selected representative image in a loop manner based on the first operation signal (second configuration).

With this configuration, since there is no need for an operation to transition the tentatively selected representative image in the opposite direction, the operation for performing tentative selection is even simpler.

With the selection device of the first or second configuration, the display signal generator can be further configured to set, for each category, a region on the display screen where the representative images representing the selection objects having the same category are disposed (third configuration).

With this configuration, it is easy to arrange displays compiled by category. The regions on the display screen that are set by category can be portions that overlap between a plurality of regions.

With the selection device of any of the first to third configurations, when the determination component determines a selection of a tentatively selected representative image corresponding to a selection object whose category is video content, the display signal generator can be further configured to set a display size of the selection object to a specific size (fourth configuration).

With this configuration, even if the number of representative images increases, the display size of the selected video content can be kept constant, allowing the user to enjoy the selected video content as desired.

With the selection device of any of the first to fourth configurations, the selection device can further include a change component configured to switch between categories of selection objects corresponding to representative images among which the tentatively selected representative image is sequentially transitioned by the transition component (fifth configuration).

With this configuration, the selection objects of each category can be tentatively selected objects.

With the present invention, all of the selection objects can be checked at the same time, and the operation for performing tentative selection and the operation for performing main selection are both simple, so selection objects can be selected more easily.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A selection device comprising:
a display signal generator configured to generate a display signal for displaying various representative images that represent various selection objects on a display screen of a display device;
a transition component configured to sequentially transition a tentatively selected representative image from among a plurality of representative images representing a plurality of selection objects having the same category based on a first operation signal; and
a determination component configured to determine a selection of the tentatively selected representative image based on a second operation signal.

2. The selection device according to claim 1, wherein
the transition component is further configured to sequentially transition the tentatively selected representative image in a loop manner based on the first operation signal.

3. The selection device according to claim 1, wherein
the display signal generator is further configured to set, for each category, a region on the display screen where the representative images representing the selection objects having the same category are disposed.

4. The selection device according to claim 1, wherein
when the determination component determines a selection of a tentatively selected representative image corresponding to a selection object whose category is video content, the display signal generator is further configured to set a display size of the selection object to a specific size.

5. The selection device according to claim 1, further comprising
a change component configured to switch between categories of selection objects corresponding to representative images among which the tentatively selected representative image is sequentially transitioned by the transition component.

6. The selection device according to claim 1, wherein
the display signal generator is further configured to arrange the representative images representing the selection objects having the same category along an imaginary loop on the display screen.

7. The selection device according to claim 6, wherein
the display signal generator is further configured to arrange centers of the representative images representing the selection objects having the same category on the imaginary loop on the display screen.

8. The selection device according to claim 6, wherein
the display signal generator is further configured to display the tentatively selected representative image in a distinguishing manner from the remainder of the representative images.

9. The selection device according to claim 1, wherein
the display signal generator is further configured to arrange the representative images representing the selection objects having the same category along an imaginary ellipse on the display screen.

10. The selection device according to claim 9, wherein
the display signal generator is further configured to arrange centers of the representative images representing the selection objects having the same category on the imaginary ellipse on the display screen.

11. The selection device according to claim 9, wherein
the display signal generator is further configured to display the tentatively selected representative image in a distinguishing manner from the remainder of the representative images.

12. The selection device according to claim 1, wherein
the display signal generator is further configured to display the tentatively selected representative image larger than the remainder of the representative images in response to the determination component determining the selection of the tentatively selected representative image.

13. The selection device according to claim 12, wherein
the display signal generator is further configured to arrange the remainder of the representative images along an imaginary loop on the display screen.

14. The selection device according to claim 13, wherein
the display signal generator is further configured to arrange centers of the remainder of the representative images on an axis of the imaginary loop on the display screen.

15. The selection device according to claim 13, wherein
the display signal generator is further configured to arrange the tentatively selected representative image relative to the remainder of the representative images such that a center of the tentatively selected representative image and a center of the imaginary loop are arranged on an imaginary loop in response to the determination component determining the selection of the tentatively selected representative image.

16. The selection device according to claim 1, wherein
the display signal generator is further configured to arrange, for each category, the representative images representing the selection objects having the same category along an imaginary loop.
